(19) United States
(12) Patent Application Publication
(10) Pub. No.: US 2026/0318528 A1
(43) Pub. Date: Oct. 15, 2026

(54) GAS BURNER

(71) Applicant: FANGKUAI BOILER CO., LTD., ANYANG (CN)

(72) Inventors: HAIGANG LU, ANYANG (CN); JIE LU, ANYANG (CN); NING QI, ANYANG (CN)

(73) Assignee: FANGKUAI BOILER CO., LTD., ANYANG (CN)

(21) Appl. No.: 19/218,401

(22) Filed: May 26, 2025

(30) Foreign Application Priority Data
Apr. 10, 2025 (CN) 2025104457635

(51) Int. Cl. F23D 14/22

(52) U.S. Cl. CPC F23D 14/22

(57) ABSTRACT

A gas burner includes a burner body defining an air chamber and a gas chamber, and at least two burner head modules; each burner head module includes an air pipe, and a first gas pipe with one end provided with a connecting head; and a guide pipe is fixed to the connecting head, the connecting head defines a gas connection channel connected to the first gas pipe, and at least two gas outlet pipes are fixed to the connecting head and connected to the gas connection channel. The gas burner has multiple burner head modules and each burner head module has multiple second gas pipes, so that the gas can be evenly dispersed, the sufficiency of gas combustion is improved, the combustion temperature is constant, the high local temperature is avoided, and the generation of nitrogen oxides is effectively reduced, thereby to reduce the emission of nitrogen oxides.

### TECHNICAL FIELD

The disclosure relates to the technical field of gas burners, and more particularly to a gas burner.

### BACKGROUND

A burner is a device that converts matter into thermal energy through the chemical reaction of combustion. It involves feeding air and fuel into the furnace at the required concentration, velocity, turbulence, and mixing method, ensuring that the fuel can be ignited and burned stably within the furnace. Burners are categorized based on type and application, including industrial burners, combustion machines, domestic burners, and special-purpose burners. They are typically made from corrosion-resistant and high-temperature-resistant materials, such as stainless steel or titanium. A gas burner, as the name suggests, refers to a burner that uses the gas as the fuel. Currently, using the burner as the heat source for the furnace is a common practice.

An ultra-low-nitrogen gas burner is disclosed in Chinese Patent No. CN107543160B. It includes an ejector nozzle, an air ejector, a combustion-supporting air passage, a jet nozzle device, a mixing swirl device, an oxygen-enriched burner head, and a reduction burner head. The ejector nozzle is located at the center of the air ejector, which is located within the combustion-supporting air passage. The front portion of the air ejector passes through the oxygen-enriched burner head and connects the reduction burner head. The jet nozzle device is located outside the air ejector within the combustion-supporting air passage, concentrically arranged with the air ejector. The mixing swirl device is sleeved on the jet nozzle device, concentric with the jet nozzle device. The mixing swirl device is capable of axial movement on the jet nozzle device. The oxygen-enriched burner head and reduction burner head adopt a cylindrical structure and are arranged concentrically. The oxygen-enriched burner head and the reduction burner head together form the burner head of the ultra-low-nitrogen gas burner. This design achieves ultra-low nitrogen emissions without increasing the excess air ratio or reducing furnace efficiency.

However, in the above-mentioned technology, the gas release is too concentrated, and the mixing area of the combustion air overlaps with the combustion area, which easily leads to the generation of transient nitrogen oxides. Additionally, the temperature of the central flame is too high, and the temperature distribution is uneven. The local high temperature can cause the temperature of the central recirculated flue gas to become excessively high, resulting in the production of nitrogen oxides. This patent does not effectively reduce the temperature of the central recirculated flue gas or the thermal-type nitrogen oxides in the central flame.

### SUMMARY

The disclosure provides a gas burner, aiming to solve the problems in the related art where the gas release is overly concentrated, the mixing area of the combustion air overlaps with the combustion area, and the temperature distribution in the combustion area is uneven, leading to the easy formation of nitrogen oxides.

The gas burner of the disclosure includes a burner body, the burner body defines an air chamber and a gas chamber, a blower is fixed to the burner body and configured to supply air into the air chamber, and a gas supply mechanism is fixed to the burner body and configured to supply gas into the gas chamber.

The gas burner of the disclosure further includes at least two burner head modules, and each burner head module includes an air pipe fixed to the burner body, and a first gas pipe fixed to the burner body and disposed within the air pipe, a connecting head is disposed at an end of the first gas pipe, a guide pipe is fixed to the connecting head, a gap is defined between the guide pipe and the air pipe for air to flow therethrough, the connecting head defines a gas connection channel connected to the first gas pipe, at least two gas outlet pipes are fixed to the connecting head, and each gas outlet pipe is connected to the gas connection channel and extends through the gap.

The gas burner of the disclosure further includes an igniter fixed to the burner body and configured to ignite the gas after mixing with the air.

The beneficial effects of the disclosure are as follows:

During use of the gas burner, the blower is activated, and the air output from the blower enters the air chamber. The air entering the air chamber will pass through an end of each air pipe and be guided through the air pipe to exit from the other end. The gas supply mechanism can deliver an external gas source to the gas chamber. The gas in the gas chamber is dispersed and ejected through the first gas pipe, the gas connection channel in the connecting head, and the gas outlet pipe. The ejected gas mixes with the air blown out, and this process ensures that air and gas are separately transported to the combustion area. The igniter is activated, and the mixed gas (i.e., the mixture of air and gas) is ignited under the influence of high-temperature flue gas in the furnace, achieving the purpose of gas combustion. Since the gas burner adopts a structure with multiple burner head modules, and each burner head module has multiple second gas pipes, the gas is evenly dispersed, improving the completeness of combustion. Additionally, the combustion temperature in the form of gas dispersion is also uniformly dispersed, which makes the combustion temperature constant, avoids the situation of high local temperature, and effectively reduces the generation of nitrogen oxides, so as to reduce the emission of nitrogen oxides.

### BRIEF DESCRIPTION OF DRAWINGS

FIG. 1 illustrates a structural schematic diagram of a gas burner in a specific embodiment of the disclosure.

FIG. 2 illustrates a structural schematic diagram of a gas input pipe, burner head modules, auxiliary combustion modules, and an igniter in a specific embodiment of the disclosure.

FIG. 3 illustrates a perspective cross-sectional view of a burner body in a specific embodiment of the disclosure.

FIG. 4 illustrates a structural schematic diagram of a wind port adjustment device in a specific embodiment of the disclosure.

FIG. 5 illustrates a cross-sectional view of the burner body and burner head modules in a specific embodiment of the disclosure.

FIG. 6 illustrates a cross-sectional view of the air pipe, connecting head, guide pipe, and gas outlet pipe in a specific embodiment of the disclosure.

FIG. 7 illustrates a structural schematic diagram of the air pipe, guide pipe, and gas outlet pipe in a specific embodiment of the disclosure.

FIG. 8 illustrates a cross-sectional view of the auxiliary combustion module in a specific embodiment of the disclosure.

FIG. 9 illustrates a schematic diagram of the gas burner installed in the furnace in a specific embodiment of the disclosure, showing the direction of the flue gas recirculation.

### DESCRIPTION OF REFERENCE NUMERALS

10: burner body; 11: mounting box; 111: mounting plate; 112: wind hood; 113: cover; 114: partition; 1141: threaded hole; 115: air inlet pipe; 116: wind port adjustment device; 1161: connecting frame; 1162: rotating shaft; 1163: drive motor; 1164: pointer; 1165: scale; 1166: wind-blocking plate; 1167: transmission mechanism; 11671: first transmission arm; 11672: connecting shaft; 11673: second transmission arm; 117: wind guide frame; 1171: wind guide surface; 12: air chamber; 13: gas chamber; 20: blower; 30: gas supply mechanism; 31: gas input pipe; 32: valve assembly; 40: burner head module; 41: air pipe; 42: first gas pipe; 421: curved section; 422: straight section; 43: support plate; 44: connecting head; 441: gas connection channel; 45: guide pipe; 46: gap; 47: gas outlet pipe; 50: auxiliary combustion module; 51: second gas pipe; 511: straight nozzle; 52: throttle valve; 521: blocking rod; 5211: drive slot; 60: igniter.

### DETAILED DESCRIPTION OF EMBODIMENTS

The following description of the technical solution of the embodiment of the disclosure will be made in conjunction with the accompanying drawings of the embodiment of the disclosure.

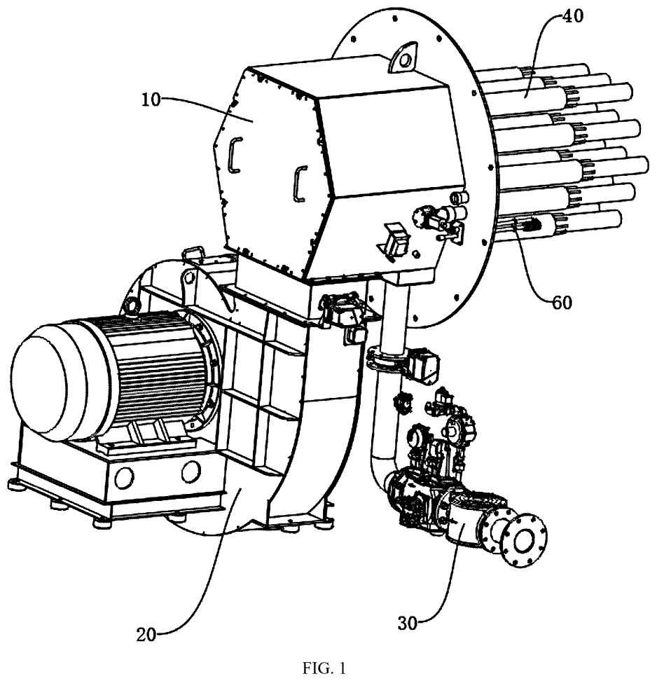

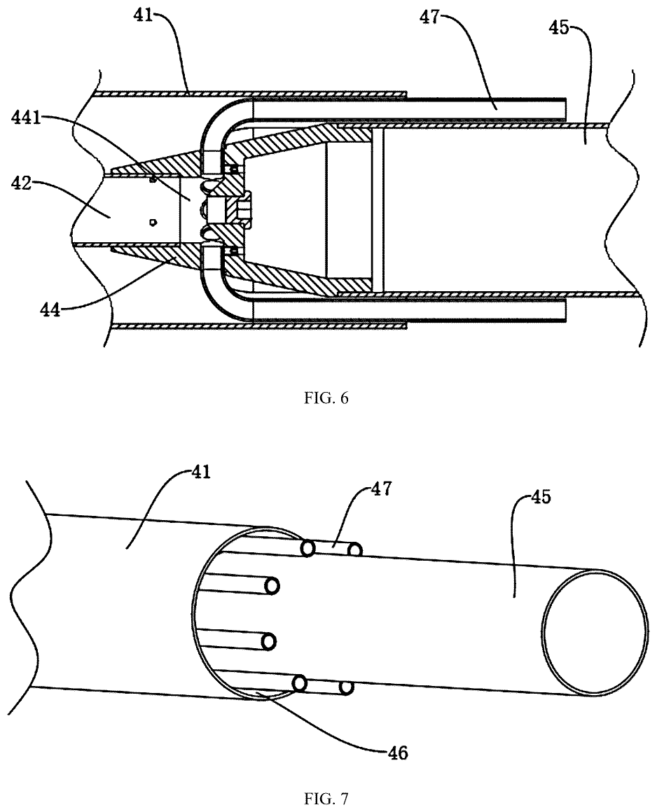

As shown in FIG. 1 to FIG. 9, the disclosure provides a gas burner, which includes a burner body 10. The burner body 10 defines an air chamber 12 and a gas chamber 13. A blower 20 is fixedly installed on the burner body 10 to inject air into the air chamber 12. A gas supply mechanism 30 is connected to the burner body 10 to supply gas into the gas chamber 13. At least two burner head modules 40 and at least two auxiliary combustion modules 50 are both installed on the burner body 10. The burner head module 40 is capable of directing air from the air chamber 12 while also directing gas from the gas chamber 13 to mix. The auxiliary combustion module 50 can also direct gas from the gas chamber 13. An igniter 60 is installed on the burner body 10 to ignite the mixed air and gas.

With reference to FIG. 1 to FIG. 5, the burner body 10 includes a mounting box 11. The mounting box 11 has the air chamber 12 and the gas chamber 13 inside. The bottom of the mounting box 11 is fixedly connected to the blower 20, and the air chamber 12 is connected to the air outlet end of the blower 20. The gas supply mechanism 30 and the burner head modules 40 are both connected to the mounting box 11.

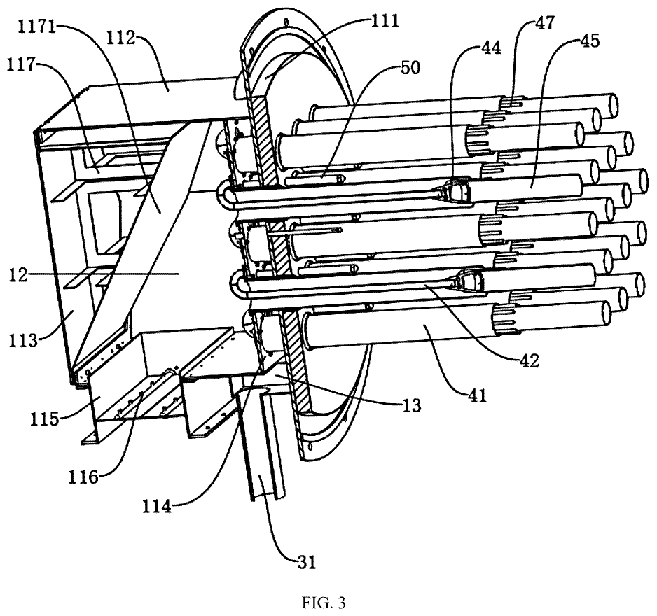

With reference to FIG. 3, the mounting box 11 includes a mounting plate 111, which is used to connect the gas burner to a furnace for assembly. A wind hood 112 is fixedly installed on the mounting plate 111. The end of the wind hood 112, facing away from the mounting plate 111, is detachably connected to a cover 113 using bolt fasteners. The cover 113 is welded with a handle so that people can hold the cover 113 in their hands. Inside the wind hood 112, a partition 114 is welded, which divides the interior space of the wind hood 112 into the air chamber 12 and the gas chamber 13. The bottom of the wind hood 112 is fixedly connected to an air inlet pipe 115. The bottom of the air inlet pipe 115 is fixedly connected to the blower 20 using bolt fasteners. It should be noted that the top of the air inlet pipe 115 is connected to the air chamber 12, and the bottom of the air inlet pipe 115 is connected to the air outlet end of the blower 20. A wind port adjustment device 116 is installed on the air inlet pipe 115 to regulate the air passing through it. A wind guide frame 117 is also pressed between the wind hood 112 and the cover 113. The wind guide frame 117 is placed inside the air chamber 12, and it has a wind guide surface 1171. The distance between the wind guide surface 1171 and the partition 114 decreases gradually from bottom to top. The wind guide surface 1171 can rectify the air entering the air chamber 12 to reduce the local resistance of the inner wall of the air chamber 12.

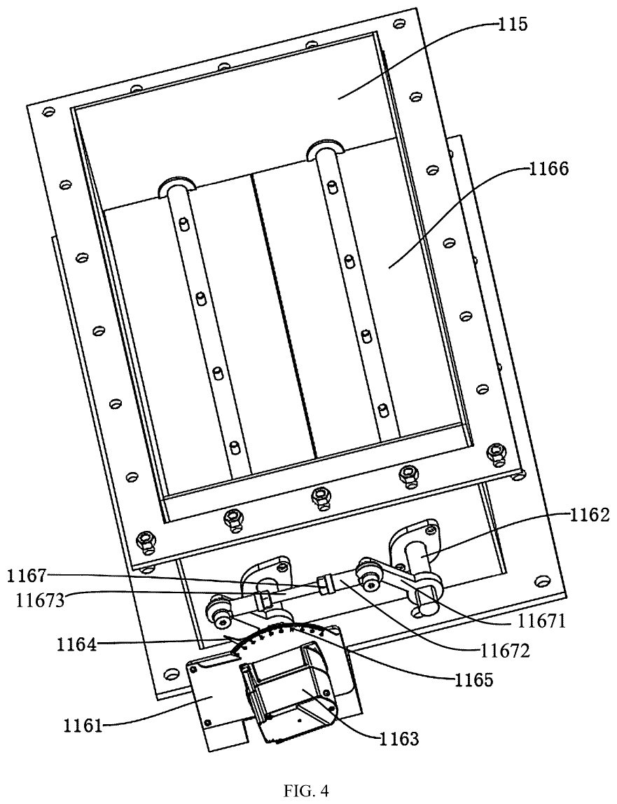

With reference to FIG. 4, exemplary, the wind port adjustment device 116 includes a connecting frame 1161 and two rotating shafts 1162. The connecting frame 1161 is welded to the air inlet pipe 115, and a drive motor 1163 is fixedly installed on the connecting frame 1161. The output end of the drive motor 1163 is fixedly connected to a pointer 1164. A scale 1165, which cooperates with the pointer 1164, is welded to the connecting frame 1161. The two rotating shafts 1162 are parallel to each other and pass through the air inlet pipe 115. The two rotating shafts 1162 are rotatably connected to the air inlet pipe 115 via bearings. On each rotating shaft 1162, a wind-blocking plate 1166 is welded and positioned inside the air inlet pipe 115. A transmission mechanism 1167 is connected between the two rotating shafts 1162 to enable synchronous rotation of the two rotating shafts 1162. An end of one rotating shaft 1162 is fixedly connected to the output end of the drive motor 1163.

The drive motor 1163 is capable of driving the rotating shaft 1162 connected to it to rotate. The rotation of the rotating shaft 1162 can, through the transmission mechanism 1167, drive the other rotating shaft 1162 to rotate synchronously. The rotation of the two rotating shafts 1162 respectively drives the two wind-blocking plates 1166 to deflect, thereby adjusting the amount of air passing through the air inlet pipe 115. At the same time, the output end of the drive motor 1163 can drive the pointer 1164 to deflect, pointing to different scales on the scale 1165, which visually indicates the displacement of the output shaft of the drive motor 1163, making it easy to control the state of the two wind-blocking plates 1166.

Exemplary, the transmission mechanism 1167 includes two first transmission arms 11671 fixedly connected to the two rotating shafts 1162, respectively. The two first transmission arms 11671 are parallel to each other. The end of each first transmission arm 11671, facing away from the respective rotating shaft 1162, is rotatably connected to a connecting shaft 11672 via a bearing. The two connecting shafts 11672 respectively connected to the two first transmission arms 11671 are rotatably connected to the same second transmission arm 11673 via bearings.

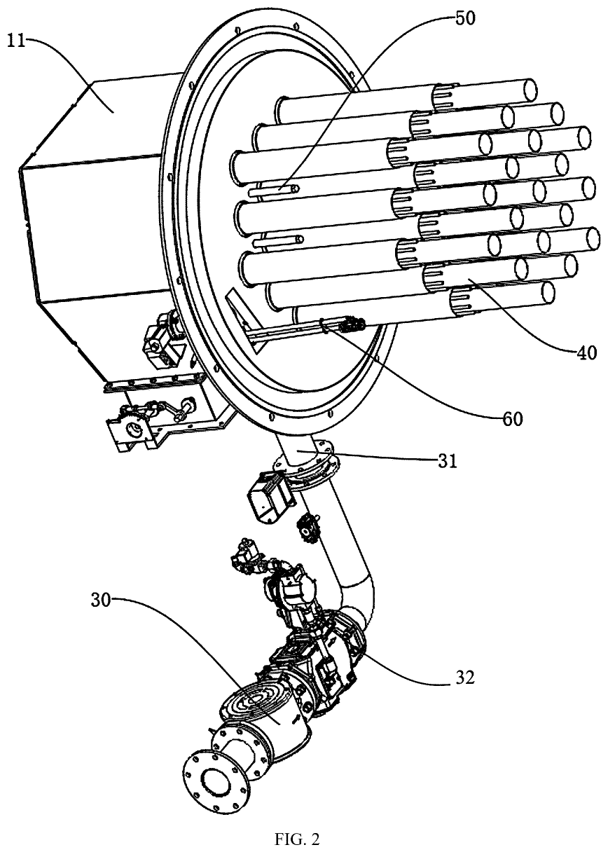

With reference to FIG. 1 and FIG. 2, the gas supply mechanism 30 is primarily used to deliver gas to the gas chamber 13. The gas supply mechanism 30 includes a valve assembly 32 connected to an external gas source. The outlet of the valve assembly 32 is connected to a gas input pipe 31, which in turn is connected to the gas chamber 13. The valve assembly 32 is capable of controlling the opening and closing of the gas input pipe 31, thereby controlling the flow of gas delivered through the gas input pipe 31 to the gas chamber 13, in order to adjust the output flow rate of the gas.

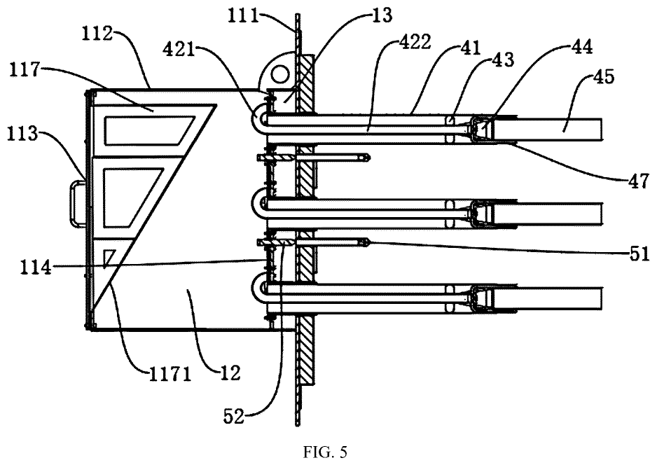

With reference to FIG. 1 to FIG. 3, FIG. 5, and FIG. 6, in this embodiment, the number of the burner head modules 40 is nineteen, and all the burner head modules 40 are evenly distributed and fixedly installed on the burner body 10. Each burner head module 40 includes an air pipe 41 and a first gas pipe 42. The air pipe 41 is fixedly connected to the partition 114 and the mounting plate 111. The first gas pipe 42 includes a curved section 421 and a straight section 422 connected to the curved section 421. An end of the curved section 421 is detachably connected to the partition 114 by bolt fasteners. The straight section 422 is located inside the air pipe 41, and the central axis of the air pipe 41 is aligned with the central axis of the straight section 422. The end of the straight section 422, facing away from the curved section 421, is detachably connected to a connecting head 44 by bolt fasteners. The end of the connecting head 44, facing away from the straight section 422, is fixedly connected to a guide pipe 45. The outer diameter of the guide pipe 45 is larger than the diameter of the straight section 422, and there is a gap 46 for the air to flow between the outer wall of the guide pipe 45 and the inner wall of the air pipe 41. Exemplarily, the outer surface of the connecting head 44 is conical, and the diameter of the connecting head 44 gradually increases in the direction of the guide pipe 45 from the straight section 422, transitioning the diameter difference between the straight section 422 and the guide pipe 45. Additionally, the conical surface of the connecting head 44 can also guide the air flowing inside the air pipe 41, ensuring the air flows smoothly toward the guide pipe 45. The connecting head 44 defines a gas connection channel 441, and at least two gas output pipes 47, which connect the gas connection channel 441, are fixedly connected to the connecting head 44. All the gas outlet pipes 47 are evenly distributed around the circumferential direction of the connecting head 44. All the gas outlet pipes 47 pass through the gap 46, in other words, the gas outlet pipes 47 extend between the end of the air pipe 41 and the end of the guide pipe 45, and the gas outlet pipes 47 almost contact the outer circumferential wall of the guide pipe 45.

In this embodiment, at least two support plates 43 are welded to the outer side of the straight section 422. All the support plates 43 are evenly distributed along the circumferential direction of the straight section 422. In this embodiment, the number of the support plates 43 is four. All the support plates 43 are capable of stably supporting the straight section 422 inside the air pipe 41, ensuring that the central axis of the air pipe 41 is aligned with the central axis of the straight section 422.

It should be noted that the air in the air chamber 12 can flow along the air pipe 41, ultimately being blown out between the air pipe 41 and the guide pipe 45. The gas in the gas chamber 13 can be discharged through the first gas pipe 42, the gas connection channel 441 in the connecting head 44, and the gas outlet pipe 47. Additionally, the gas with a certain velocity ejected from the gas outlet pipe 47 will be released axially forward close to the outer circumferential wall of the guide pipe 45, and the gas concentration released near the gas outlet pipe 47 is the highest. As the gas is released towards the end of the guide pipe 45, the gas concentration gradually decreases. The gas can be ignited near the end of the guide pipe 45, effectively reducing the generation of nitrogen oxides. It should also be noted that the position where the gas outlet pipe 47 extends between the air pipe 41 and the guide pipe 45 can be adjusted based on the actual pairing between the burner and the furnace.

Referring to FIG. 2, FIG. 3, FIG. 5, and FIG. 8, in this embodiment, the number of the auxiliary combustion modules 50 is twelve. Each auxiliary combustion module 50 includes a second gas pipe 51 and a throttle valve 52 corresponding to the second gas pipe 51. The second gas pipe 51 is fixedly connected to the burner body 10 and connected to the gas chamber 13. The length of the second gas pipe 51 is shorter than that of the air pipe 41. The second gas pipe 51 is provided with a linear nozzle 511. The gas in the gas chamber 13 can flow through the second gas pipe 51 and be discharged through the linear nozzle 511. The throttle valve 52 can adjust the gas flow through the second gas pipe 51. The partition 114 defines a threaded hole 1142, and the throttle valve 52 includes a blocking rod 521 threaded into the threaded hole 1142. The central axis of the blocking rod 521 is collinear with the central axis of the second gas pipe 51. The end of the blocking rod 521 close to the second gas pipe 51 is conical, and the end of the blocking rod 521, facing away from the second gas pipe 51, is provided with a drive slot 5211. A screwdriver can be inserted into the drive slot 5211, and turning the screwdriver will cause the blocking rod 521 to rotate, forcing the blocking rod 521 to move along its axial direction, thereby moving it closer to or further away from the second gas pipe 51, to adjust the gas intake of the second gas pipe 51.

Continuing to refer to FIG. 1 and FIG. 2, the igniter 60 is installed on the mounting plate 111 of the burner body 10 and is capable of igniting the gas discharged by the gas burner.

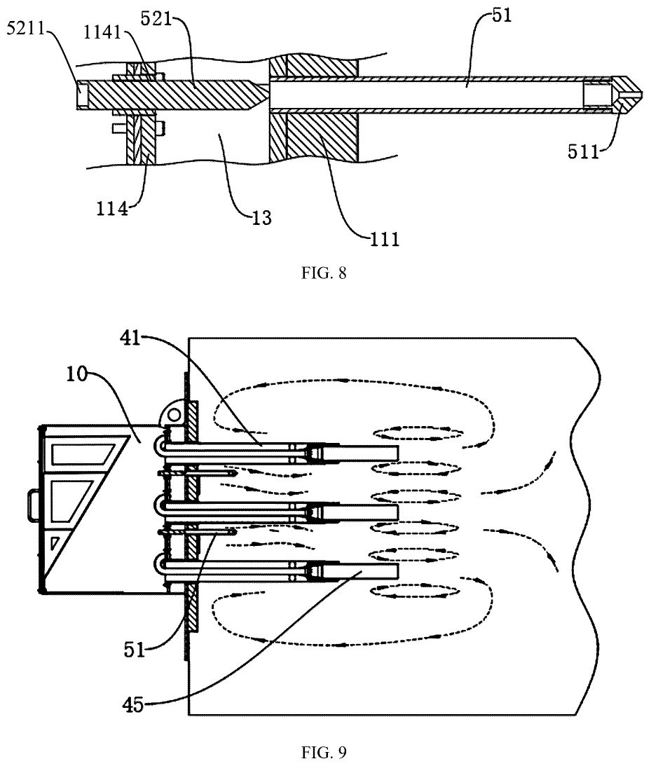

In use, the blower 20 is started, and the air output by the blower 20 enters the air chamber 12 through the air inlet pipe 115. The air entering the air chamber 12 is directed towards the air pipes 41 by the guide surface 1171 on the air guide frame 117 and enters through one end of each air pipe 41. The air is then guided through the air pipe 41 and blown out from the other end. Meanwhile, the valve assembly 32 is opened, allowing the external gas source to be delivered to the gas chamber 13 through the gas input pipe 31. The gas in the gas chamber 13 is dispersed through each first gas pipe 42, the gas connection channel 441 in the connecting head 44, and each gas outlet pipe 47. The discharged gas mixes with the blown air. This process ensures that the air and gas are separately transported to the combustion area. The igniter 60 is activated to ignite the mixed gas, and under the influence of high-temperature flue gases in the furnace, the mixed gas is ignited, achieving the purpose of gas combustion. Since the gas burner uses a structure with multiple burner head modules 40, and each burner head module 40 has multiple second gas pipes 51, the gas is evenly dispersed, as shown in FIG. 9, improving the completeness of the gas combustion. Additionally, the form of dispersed gas combustion ensures that the combustion temperature is also evenly distributed, keeping the combustion temperature constant. This prevents localized high temperatures, effectively reducing the generation of nitrogen oxides and achieving the reduction in nitrogen oxide emissions.

Additionally, in the furnace, the high-temperature flue gases in the furnace fill the area around the air pipes 41. Since the flue gases contain a small amount of oxygen, the oxygen around the air pipes 41 is easily combined with the flue gases under high temperature to form nitrogen oxides. To reduce the nitrogen oxides generated in this area, the throttle valves 52 are controlled to adjust the gas flow through the second gas pipes 51, allowing the gas in the gas chamber 13 to flow through the second gas pipes 51 and be discharged through the linear nozzles 511. The discharged gas is placed around the air pipes 41, as shown in FIG. 9. Under the influence of high-temperature flue gases, the gas is ignited to consume the oxygen in the flue gases in that area, further reducing the formation of nitrogen oxides and decreasing nitrogen oxide emissions.

What is claimed is:

1. A gas burner, comprising:
a burner body (10) defining an air chamber (12) and a gas chamber (13);
a blower (20) fixed to the burner body (10) and configured to supply air into the air chamber (12);
a gas supply mechanism (30) fixed to the burner body (10) and configured to supply gas into the gas chamber (13);
at least two burner head modules (40), and each of the at least two burner head modules (40) comprising:
an air pipe (41) fixed to the burner body (10);
a first gas pipe (42) fixed to the burner body (10) and disposed within the air pipe (41);
a connecting head (44) disposed at an end of the first gas pipe (42), and the connecting head (44) defining a gas connection channel (441) connected to the first gas pipe (42);
a guide pipe (45) fixed to the connecting head (44);
a gap (46) for air circulation defined between the guide pipe (45) and the air pipe (41); and
at least two gas outlet pipes (47) fixed to the connecting head (44), each of the at least two gas outlet pipes (47) being connected to the gas connection channel (441) and extending through the gap (46); and
an igniter (60) fixed to the burner body (10) and configured to ignite the gas after mixing with the air.

2. The gas burner as claimed in claim 1, further comprising:
at least two auxiliary combustion modules (50), and each of the at least two auxiliary combustion modules (50) comprising:
a second gas pipe (51) fixed to the burner body (10) and connected to the gas chamber (13), a length of the second gas pipe (51) being shorter than that of the air pipe (41), and the second gas pipe (51) being provided with a linear nozzle (511); and
a throttle valve (52) disposed on the burner body (10) and corresponding to the second gas pipe (51), and the throttle valve (52) being configured to regulate a gas flow rate through the second gas pipe (51).

3. The gas burner as claimed in claim 2, wherein the burner body (10) defines a threaded hole (1141), and the throttle valve (52) comprises:
a sealing rod (521) threadedly connected with the threaded hole (1141) of the burner body (10), a central axis of the sealing rod (521) being collinear with a central axis of the second gas pipe (51), an end of the sealing rod (521) adjacent to the second gas pipe (51) being conical in shape, and an end of the sealing rod (521) facing away from the second gas pipe (51) defining a drive slot (5211).

4. The gas burner as claimed in claim 1, wherein the burner body (10) comprises:
a mounting box (11), the air chamber (12) and the gas chamber (13) being both disposed within the mounting box (11), and the mounting box (11) comprising:
an air inlet pipe (115) disposed at a bottom of the mounting box (11) and connected to the air chamber (12), and a bottom of the air inlet pipe (115) being connected to an air outlet end of the blower (20);
a wind port adjustment device (116) mounted on the air inlet pipe (115) and configured to regulate air flow through the air inlet pipe (115); and
an air guide frame (117) provided on the mounting box (11) and disposed within the air chamber (12), the air guide frame (117) having a guide surface (1171), and air entering the air chamber (12) via the air inlet pipe (115) being directed along the guide surface (1171) toward the air pipe (41).

5. The gas burner as claimed in claim 4, wherein the wind port adjustment device (116) comprises:
a connecting frame (1161) fixed to the air inlet pipe (115);
a drive motor (1163) fixed to the connecting frame (1161);
two rotating shafts (1162) parallel to each other and extending through the air inlet pipe (115); and the two rotating shafts (1162) being rotatably connected to the air inlet pipe (115);
wind-blocking plates (1166) disposed in the air inlet pipe (115), and the two rotating shafts (1162) being fixed to the wind-blocking plate (1166), respectively; and
a transmission mechanism (1167) connected between the two rotating shafts (1162) and configured to control synchronous rotation of the two rotating shafts (1162);
wherein an end of one of the two rotating shafts (1162) is fixedly connected to an output end of the drive motor (1163).

6. The gas burner as claimed in claim 5, wherein the transmission mechanism (1167) comprises:
two first transmission arms (11671) respectively fixed to the two rotating shafts (1162), the two first transmission arms (11671) being parallel to each other;
two connecting shafts (11672), each of the two connecting shafts (11672) being rotatably connected to an end of a respective one of the two first transmission arms (11671) facing away from the respective rotating shaft (1162); and
a second transmission arm (11673), rotatably connected to the two connecting shafts (11672).

7. The gas burner as claimed in claim 5, wherein a pointer (1164) is fixed to the output end of the drive motor (1163), and a scale (1165) cooperating with the pointer (1164) is fixed to the connecting frame (1161).

8. The gas burner as claimed in claim 1, wherein the first gas pipe (42) comprises:
a curved section (421); and
a straight section (422) connected to the curved section (421);
wherein an end of the curved section (421) is fixedly connected to the burner body (10), the straight section (422) extends through the air pipe (41), at least two support plates (43) are fixed to an outer surface of the straight section (422), and all of the at least two support plates (43) are evenly distributed along a circumferential direction of the first gas pipe (42).

9. The gas burner as claimed in claim 1, wherein an outer surface of the connecting head (44) is conical in shape, and a diameter of the connecting head (44) gradually increases in a direction from the first gas pipe (42) toward the guide pipe (45).

10. The gas burner as claimed in claim 1, wherein the gas supply mechanism (30) comprises:
a valve assembly (32) configured to connect an external gas source; and
a gas input pipe (31) connected to an outlet end of the valve assembly (32), and the gas input pipe (31) being connected to the gas chamber (13).
